(19) United States
(12) Patent Application Publication
(10) Pub. No.: US 2006/0179805 A1
(43) Pub. Date: Aug. 17, 2006

(54) Quick exchange tool bar system

(76) Inventor: Richard L. Quiring, Stony Plain (CA)

Correspondence Address: Richard L. Quiring, P.O. Box 2476, Stony Plain, AB, T7Z 1X9, CA

(21) Appl. No.: 11/322,356

(22) Filed: Jan. 3, 2006

Related U.S. Application Data
(60) Provisional application No. 60/643,136, filed on Jan. 12, 2005.

(51) Int. Cl. A01D 82/00

(52) U.S. Cl. 56/1

(57) ABSTRACT

The Quick Exchange three Point hitch toolbar design allows for the toolbar to function as a multi task system for a variety or work requirements. The toolbar system is comprised of a number of pieces: a main frame tool bar beam, receiver couplers, connecting arms, expansion couplers, expansion arms, expansion bars and beams that inter connect to form an expandable toolbar. Changes are easily accomplished by removing a holding pin then adding or removing an expansion bar and/or a connecting bracket and reinstalling the holding pin. This system makes it possible to perform different tasks by changing the width, length or depth of the tool bar and then attaching the needed accessory pieces. This tool bar system accepts pre manufactured 3PH equipment eg) cultivator shank, disk gang, carry tote etc. or an individual can use this tool bar system to custom fit accessory tool pieces for their specific requirements.

### TECHNICAL FIELD OF THE INVENTION

This invention relates to toolbars that attach to three point hitch equipped tractors, trucks and ATV's that operate primarily but not exclusively in the agricultural and industrial sectors for a variety of work related tasks such as tillage, seeding and material handling

### BACKGROUND OF THE INVENTION

Traditionally manufacturers of three point hitch toolbars that are used in the agricultural and industrial sectors are producing toolbars that are for the most part singular task in their function.

There are a number of restrictive characteristics that accompany the traditional toolbar manufactured models.

First expandability is difficult at best and not achievable at worst. These toolbar models are only available in a few pre determined widths, the most common being the 60 to 80 inch range. If a wider or narrower toolbar is required the customer would have to purchase or make a new toolbar in the desired width and weight carrying capacity. This also may require different three point hitch and accessory tool piece mounting brackets.

Adding to the length of a traditional toolbar with a second toolbar beam is also difficult since the needed toolbar ties come in pre manufactured lengths and in most cases are not adjustable. So variable spacings between two toolbar beams may require a number of matching sets of different lengths of these toolbar ties. In other cases the toolbar and frame may be welded together to form a rigid one piece frame.

Since toolbars come in 4 different styles, diamond, square, round, and rectangular connecting clamps for the toolbar tie ends may not be compatible or available for the consumers specific expansion needs.

Further more, flexibility and exchangeability is not a priority for the traditionally manufactured toolbars. They may be able to have some variations within their particular field of operation, such as a toolbar that has been equipped for tillage work may be able to accept different styles of cultivator shanks, but it would not be possible for the toolbar to be adapted to another category of work such as a material handler. This toolbar construction may not allow for much flexibility in its load carrying capabilities.

Finally, affordability is more difficult with traditionally manufactured toolbars because one size does not fit all. This results in more duplication of raw material and inventory of finished products for the manufacturer, retailer and the consumer. Affordability has also been affected by the lack of compatibility of exchangeable parts within and between manufacturers product lines.

### SUMMARY OF THE INVENTION

The object of the present invention is to provide a quick exchange multi task toolbar system capable of performing a variety of chores primarily, but not exclusively within the agricultural, landscape and industrial sectors. This toolbar system makes it possible for the tractor operator to go from tillage to seeding to material handling duties without ever disconnecting the toolbar main frame from the tractor.

This toolbar system is also capable of quick expansion in width, length and depth to meet the ever changing demands on the work site. This capability allows for a variety of shapes and sizes of the toolbar system, reducing the need to purchase multiple pieces of the same style of equipment for every size of tractor or task. This expansion capability also works in reverse, allowing for one to reduce the size of the toolbar system for smaller work sites and for easier storage of the toolbar in barns or small sheds.

This toolbar system can also lower the financial investment for manufacturers, retailers and consumers because there will be less duplication of raw materials and inventories of finished products.

The four main objectives of this invention are summed up in four words: flexible, exchangeable, expandable and affordable.

### BRIEF DESCRIPTION OF THE DRAWINGS

1. For a more complete understanding of the invention

FIG. 1 discloses a side view of the quick exchange toolbar system assembled main frame.

FIG. 2 shows a side view of the toolbar system assembled main frame attached to a tractor equipped with a three point hitch system.

FIG. 3 shows the front view of a main frame toolbar beam while FIG. 3 A shows the end view of the toolbar beam with an inserted quick release pin.

FIG. 4 shows a side view of a single adjustable receiver coupler and FIG. 4 A shows the bottom side of the adjustable receiver coupler with a weld-on connector plate.

FIG. 5 shows a side view of a double adjustable receiver coupler with a slider tube, FIG. 5 A is a front view of the same double adjustable receiver coupler.

FIG. 6 shows a side view of the adjustable 3 PH top link connector arm.

FIG. 7 shows a side view of a 3 Ph lift arm connector insert tube while FIG. 7 A shows a top view of the same 3 PH lift arm connector insert tube.

FIG. 8 is a top view of a quick exchange toolbar system main frame with three different styles of accessory connector arms.

FIG. 9 is a front view of a receiver coupler with an inserted quick release pin.

FIG. 10 is a 2 dimensional view of a T style accessory arm.

FIG. 11 shows a top view of an assembled toolbar main frame connected to an auxiliary toolbar beam.

FIG. 12 is a side view of an expansion coupler and FIG. 12 A is an end view of the same expansion coupler.

FIG. 13 is a 2 dimensional view of an expansion bar while FIG. 13 A shows a side view of an expansion bar inserted into a partial view of a receiver coupler.

### DETAILED DESCRIPTION OF THE INVENTION

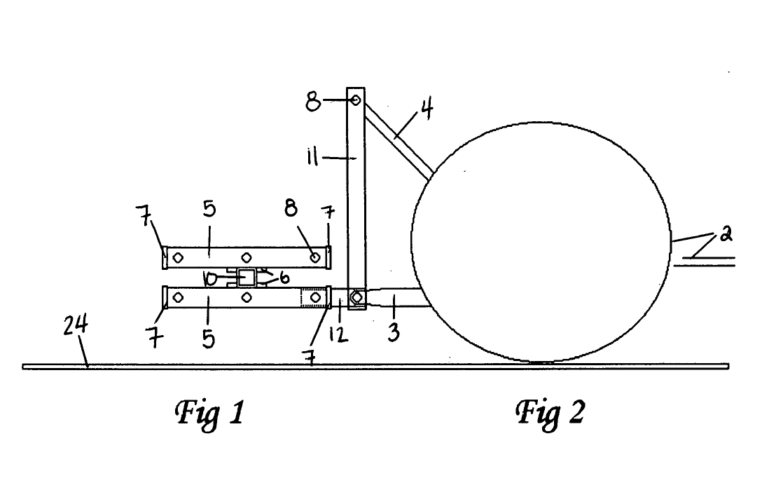

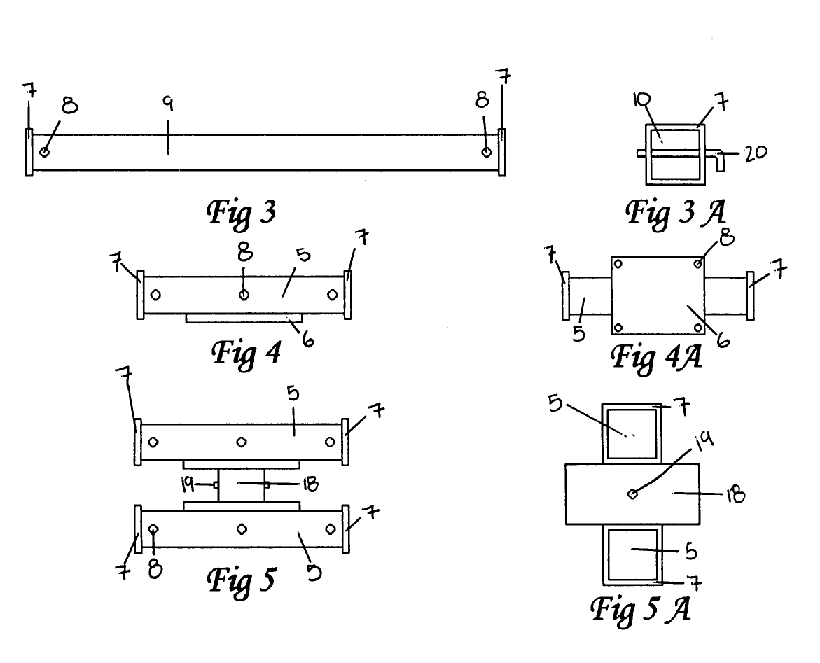

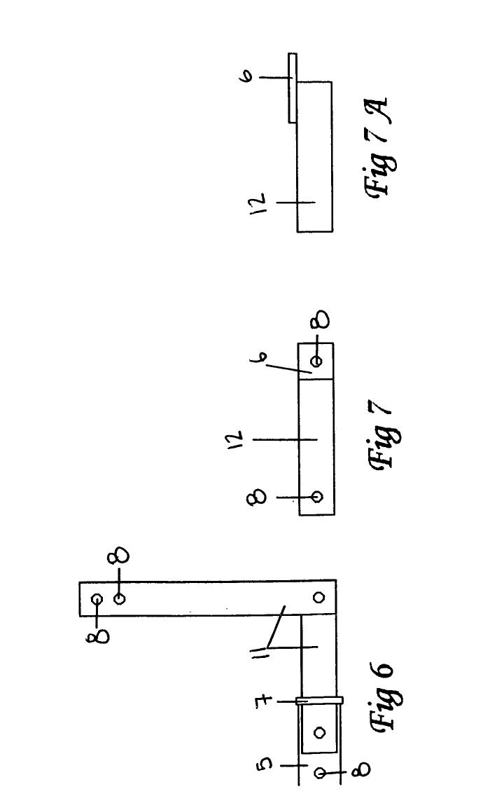

1. In accordance with the object of the invention set forth in the summary of the invention, the Quick Exchange Toolbar System main frame (1) is shown in FIGS. 1 and 2 is mounted on a typical tractor (2) that is equipped with a three point hitch that uses two lower lift arms (3) and a center adjustable top link connector (4) as connector points for attaching the toolbar system to the tractor. The Toolbar hitch connecting hardware will be discussed later in FIGS. 6 and 7.

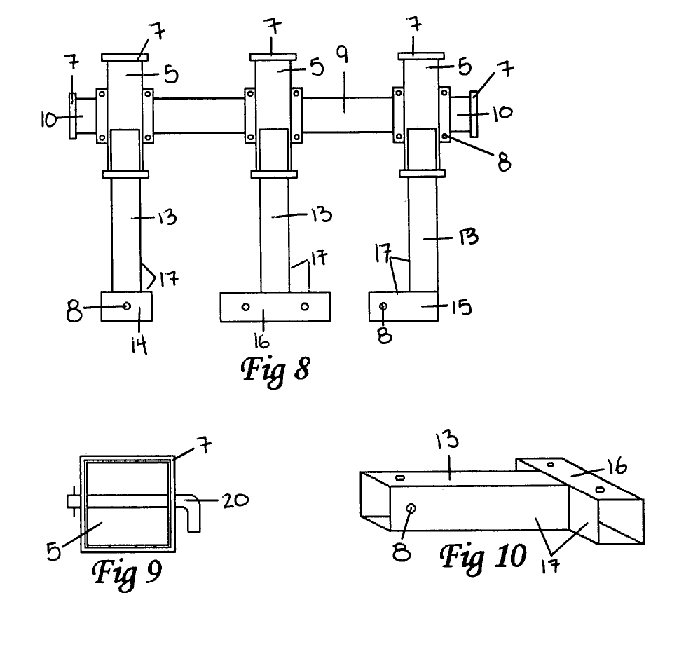

The Toolbar System main frame shown in FIGS. 1 and 2, make up begins with a hollow steel tube identified as the toolbar beam (9). This beam is available in a variety of lengths. Each end of the toolbar beam functions as receiver end couplers (10). These receiver end couplers make it possible to increase or decrease the width of the toolbar beam by inserting or removing expansion bars (22) or accessory insert tubes (13) from the end coupler. There are holes (8) drilled near the end of the toolbar beam (9) for inserting a temporary fastener such as a bolt or a pin (20) that goes through both the beam (9) and the expansion bar (22) or connector insert tube (13) to hold them securely in place. Each end of the toolbar beam is fitted with a re-enforcement band (7). This band slides over the beam end and is welded to the beam. This band gives the end of the beam extra support for handling the pressure that occurs when expansion bars or connecting arms are used in work activities. These expansion bars and arms will be described in more detail in the discussion in FIG. 8-13.

The second component required for assembling the toolbar system main frame are the adjustable receiver couplers (5) shown in FIGS. 4 and 5. These couplers design starts with a hollow steel tube. Both ends are left open for the inserting of expansion bars (22) or accessory receiver insert tubes (13). The receiver couplers (5) have a number of pre drilled holes (8) for inserting fasteners (20). These holes allow for adjusting the length of expansion bars (22) and accessory insert tubes (13) within the length of the adjustable receiver couplers, both ends of the receiver coupler are fitted with re enforcement bands (7) that are slid over the ends of the receiver coupler and welded in place. These bands give added strength and support when the receiver couplers are used in heavy down or side pressure loads. Each of the adjustable receiver couplers (5) has a steel flat plate (6) welded to the receivers bottom side for securing the receiver to the toolbar beam (9). These weld-on flat plates are of sufficient size to allow four holes (8) at appropriate spacings so that a securing bolt or pin (20) can be placed through the plate and along the outside walls of the toolbar beam (9). The receiver coupler is placed on either the top or bottom side of the toolbar beam at the desired location and at a right angle to the toolbar beam. Bolts are put through the holes in the receiver couplers weld on flat plate (6) the bolts (20) need to be long enough to extend past the toolbar beam and pass through the holes in a second independent flat plate (6) that is a match to the one welded on to the bottom of the receiver coupler. Washers and nuts are then put on to the four bolts and tightened so that the receiver coupler stays in the desired position. Two U bolts (20) can be used in place of the second plate (6) and the four bolts (20) when just a single receiver coupler is attached at a desired location on the toolbar beam (9). The main frame of the toolbar system also uses a quick exchange three point hitch connector system that includes a top link connector arm (11), a receiver insert tube (13) and two matching lift arm tubes (12) shown in FIGS. 6 and 7.

The connector arm (11) is comprised of two matching lengths of flat iron plates positioned in a vertical or upright position, near the top of the flat iron plates is a hole (8) suitable for inserting a top link connector pin (20) a little further down on the connecting arm flat plates (11) is another hole (8) this hole is used for a spacer bolt or pin (20) this spacer bolt or pin serves to keep the two flat plates a fixed distance apart. The bottom of the connecting arm flat plate is welded to one end of the receiver insert tube (13) one of the flat plates (11) is welded to each side of the receiver insert tube (13). This insert tube is a length of square tubular steel that is a little smaller dimension than the adjustable receiver couplers (5) so that the insert tube can slide into the receiver coupler. There are two sets of holes (8) in the insert tube that are the same size as the holes in the receiver couplers (5) to allow for the same size bolt or pin (20) to be inserted through both the receiver coupler (5) and the receiver insert tube (13) at the same time to secure the top link connector arm (11) to the toolbar main frame (1), the two sets of holes in the connector arms insert tube (13) allows for the connector arm to have two different positions for adjustment length. The lift arm connector insert tubes (12) is a length of hollow steel tubing that is a slightly smaller dimension so that it can slide into an adjustable receiver coupler (5). This connector tube (12) has two sets of holes (8) that are the same size as the holes (8) in the adjustable receiver couplers (5) so that the same size bolt or pin (20) can be inserted through both the receiver coupler and the lift arm connector tube in order to secure the connector tube (12) in place. The two sets of holes (8) in the insert tube allow for two different positions for adjusting the length forward of the lift arm connector tube (12). The outer end of the connector tube has a flat pate (6) welded to one side of the insert tube (12) this plate is the same width as the tube but extends beyond the tube end far enough to allow for a hole (8) that is of sufficient size in order to attach a lift arm pin (20) that will allow a tractor (2) or other suitable vehicle with three point hitch lift arms (3) to be connected to the toolbar system lift arm connectors (12). The toolbar system lift arm connectors (12) are reversible. This means that there is no left or right side connector; the one style will fit either the right or left side.

Another component in the toolbar system is the accessory connector arms (17) shown in FIGS. 8, 9 and 10. These connector arms are used for attaching accessory tool pieces such as cultivator shanks or planters to the main frame toolbar receiver couplers (5) or the toolbar beam end couplers (10). These connector arms are of two piece construction starting with a receiver insert tube (13). This is a length of hollow square steel tubing that is of lesser dimension than the adjustable receiver couplers (5) and the toolbar beam end couplers (10) so that the receiver insert tube (13) can slide into the receiver couplers (5) (10). Near the bottom end of the insert tube are two sets of holes (8) on all four sides of the square insert tube (13) these holes (8) are used for connecting the insert tube into the receiver couplers and inserting a bolt or pin (20) through holes (8) in both the receiver couplers and the insert tubes. The second component is the accessory connector heads (14) (15) (16). These are weld on hollow square steel tubes of different lengths to form the different styles of connector arms (17). These connector heads (14) (15) (16) can be used in either a vertical or a horizontal position.

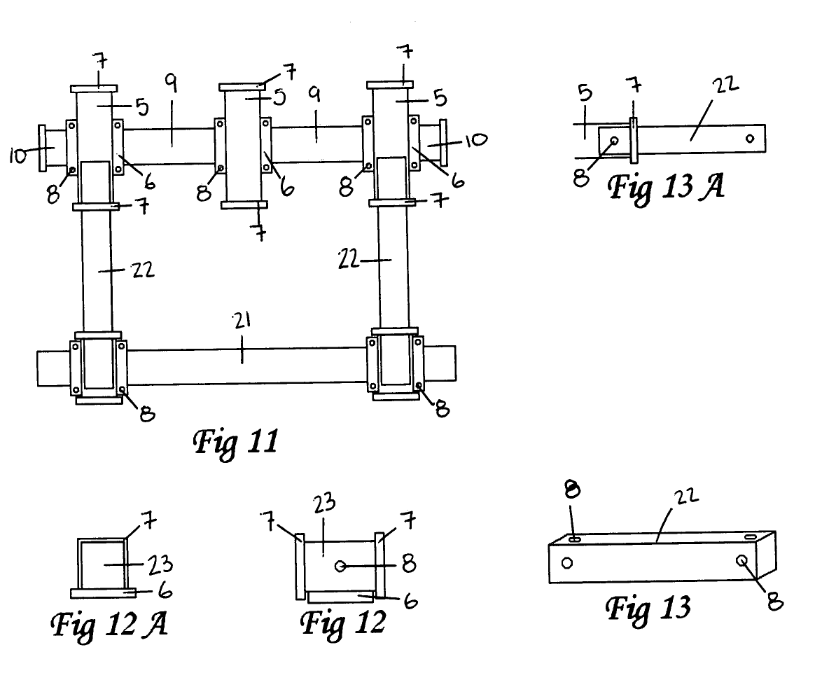

Another quick exchange component in the toolbar system is the expansion bars (22) FIGS. 11 and 13. They are of various lengths and are a hollow square steel tube with holes (8) on all four sides near the ends. These holes (8) are of sufficient size to accept a fastener (20) such as a bolt or pin that will secure the expansion bar (22) securely inside of a receiver coupler (5) (10) while the other end of the expansion bar is connected to or through the inside of an expansion coupler (23) FIG. 12. The expansion coupler is a length of hollow square steel tubing with a re-enforcement band (7) slid over the coupler tube end and welded in place. There is a hole (8) drilled through the center of both sides for inserting a fastener bolt or pin (20) through the coupler (23) and the expansion bar (22) at the same time. This expansion coupler can be positioned and secured along the expansion bar at various locations in pre drilled holes (8). The bottom of the expansion coupler (23) has been fitted with a weld on connector flat plate (6) that has four holes (8) at suitable locations for using bolts or pins to attach an expansion beam in a horizontal position with the help of a second, independent connector flat plate (6) that is a match to the weld on flat plate. This second flat plate (6) is placed under the expansion beam (21) and is secured in place with four fasteners (20) such as a bolt or pin that goes through the holes (8) in both of the flat plates (6) but stay along the outside walls of the expansion beam (21). This second independent flat plate and four bolts can be substituted by using two U bolt style fasteners (20) of suitable dimensions. These expansion couplers can also be used in a vertical position for attaching and securing accessory tool pieces such as gauge wheels that have vertical or upright attaching connector bars.

The expansion toolbar beam (21) FIG. 11, can be the same as the main frame toolbar beam (9) with the receiver style ends (10) or the expansion beam can just be a length of hollow square steel tubing. This expansion beam (21) can also be attached to the toolbar system main frame (1) with the use of accessory connector arms item (17) with the I style connector head (14) and used in a horizontal position so that the expansion beam (21) can be slid through the I style connector (14) and secured in place with a fastener (20) such as a bolt, pin or set screw.

I claim that the Quick Exchange Toolbar System has been designed as an attachment for use on three point hitch equipped tractors, trucks and all terrain vehicles that operate primarily but not exclusively in the agricultural and industrial sectors, incorporates the following 3 distinctives.

1. The quick exchange toolbar system functions as a multi task piece of equipment that is comprised of a variety of inter-connecting hardware components including:
a main frame toolbar beam, said toolbar beam having end couplers suitable for fitting over exchangeable interlocking accessory hardware component pieces
an adjustable receiver couplers, said adjustable receiver couplers having the capability to be affixed at variable positions at a right angle on the toolbar beam
an accessory connector arm that is capable of being inter locked as a temporary exchangeable, adjustable component within the adjustable receiver coupler or the toolbar beam end coupler
an expansion bar that when interlocked within the toolbar beam end couplers or the adjustable receiver couplers produces an expanded toolbar system in width, length or depth
an expansion coupler capable of being temporarily attached to an expansion bar by fitting over the bar in an interlocking manner while at the same time being temporarily attached to an expansion beam or an accessory tool piece connector
an expansion beam having the capability to accept the attachment of the adjustable receiver couplers or accessory tool piece component in a temporary fashion in order to add to the width, length or depth of the toolbar system

2. The quick exchange toolbar systems adjustable receiver coupler of claim 1 affords the quick exchange toolbar system its expandable capabilities with:
an ability to accept an individual receiver insert tube from both ends of the receiver coupler so as to perform two different functions at the same time
a capability that allows for a number of different position settings within the receiver coupler for the interlocking of accessory and expansion hardware pieces.
a weld on flat plate with a matching independent plate is one way of attaching the adjustable receiver coupler to the toolbar beam in claim 1
a weld on slider tube is a second method used for attaching the adjustable receiver coupler to the toolbar beam in claim 1

3. The quick exchange toolbar system accessory connector arms of claim 1 give the toolbar system the ability to be a multi task toolbar system for use in a variety of work classifications
this ability accepts the variety of accessory tool pieces needed whether they are pre manufactured or custom built pieces as an exchangeable feature.
an expandable toolbar system in width, length or depth is achieved with the inter-locking of these accessory connecting arms within the adjustable receiver couplers of claim 2.
